(19) United States
(12) Patent Application Publication
(10) Pub. No.: US 2007/0202474 A1
(43) Pub. Date: Aug. 30, 2007

(54) Reader interfaced text orchestration

(76) Inventor: Justin William Miller, Chatsworth, CA (US)

Correspondence Address: Justin William Miller, 10611 Overman Ave., Chatsworth, CA, 91311, US

(21) Appl. No.: 11/711,414

(22) Filed: Feb. 24, 2007

Related U.S. Application Data
(60) Provisional application No. 60/776,266, filed on Feb. 24, 2006.

(51) Int. Cl. G09B 19/00

(52) U.S. Cl. 434/156

(57) ABSTRACT

Reader Interfaced Text Orchestration constitutes a new and faster way of reading. The process uses a computer program to sequence a selected text and then flashes the words of the text on a display. The words appear and disappear very rapidly within a confined space, allowing the user to read the text quickly and with minimal need to move the eyes. The user can employ controls to speed the text up, slow the text down, and flash multiple words at a time. These and other customizable process elements allow the user to optimize the effectiveness and efficiency of reading.

### CROSS-REFERENCE TO RELATED APPLICATION

This application claims the benefit of Provisional Patent Application numbered 60/776,266, dated Feb. 24, 2006, by Justin William Miller, for the invention titled Reader Interfaced Text Orchestration.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Written language is ubiquitous in civilization. It is used in signs to direct traffic, on cereal boxes to list ingredients, in books to tell stories, and in law to define the rules of cooperation. Though the uses of written language have multiplied, the process for making sense of it has remained essentially the same. Most people read today much the same way people have read for centuries. Reading the written English language, a reader focuses his eyes on the left-most and upper-most part of a text, moves his focus along the words, the spaces, and the punctuation marks, gleans meaning from the symbols, until he reaches the end of a line. At this point, if the text continues, the reader moves his focus along the surface upon which the text is written, back to the left and slightly down until he finds the beginning of the next line. He then moves his focus along the text to the right again and repeats the pattern until he is done.

The process works well enough for some people. There are others who find it boring and still others who find it intolerable. Many of the shortcomings of reading arise from the fact that since the text is static, that is, it doesn't move, a reader's eyes must be dynamic, that is, they must move. Often, a reader will set a comfortable pace for himself and take much longer to read a text than he otherwise might have. Or, from time to time, when looking for the beginning of the next line in a text, a reader might skip a line or begin rereading the same line, wasting a few moments of time. Additionally, a reader's concentration often slips away to other things, though his eyes keep plodding along, mechanically moving from word to word, line to line, paragraph to paragraph. Readers commonly find themselves in an unfamiliar place in a text, having no recollection of how they got there or what was included in the text they had just “read.” They then must go back and find the last part of the text that seems familiar and reread the parts their eyes had just spent time and energy to focus on. Even with sustained concentration, many readers will sound out the words they read, silently imagining an inner voice pronouncing each syllable, culling the meaning from each word through auditory recognition. Some will even move their lips as they read. None of these patterns by itself presents much difficulty. But, together, these difficulties make reading take far longer than many would like and contribute to many people's aversion to the process.

There are techniques that can help mitigate these difficulties. Software is available that can help exercise the eyes so that they can move faster and with more agility. Speed reading techniques exist that help readers to more efficiently find the next line in a text, focus on more words, or set a more ambitious pace. There are courses aimed at overcoming many of the inefficiencies of reading. But there are drawbacks to these solutions. Namely, they often require a lot of effort, a lot of time, and a lot of money, or, at least, more of each than many people are willing to spend.

### BRIEF SUMMARY OF THE INVENTION

Reader Interfaced Text Orchestration [RITO] is a process that differs substantially from traditional reading, speed reading, and other reading processes and techniques in use today. RITO uses a text in digital form, a computer, a program, a display, an interface, a reader, and the reader's input and feedback. Employing these elements, RITO manipulates the text in a way that enables a person to read it with great speed and comprehension. One method RITO employs in order to accomplish this is to flash words rapidly within a restricted field on a display. One word appears after another in sequence, that is, in the same order they appear in the text. The reader can focus on the field and quickly recognize and comprehend each word without the need to move his eyes. The reader can manipulate the process while the text is flowing, that is, while it is flashing in sequence in the field, in order to optimize reading effectiveness and efficiency. The reader can begin the flow of text, speed it up, so it flashes more rapidly, slow it down, pause it, resume it, jump back 10 words in the text sequence, for instance, jump forward to the beginning of the next paragraph, for instance, and/or employ many other functions to optimize the process. The reader can also input settings and enable options before the flow of text begins, while it is flowing, or while it is paused. RITO incorporates an extensive range of functionality, such as flashing multiple words at one time, using multiple fields at one time, allowing different flash durations for different types of words, and providing different options for text movement and appearance on the display. The various elements, functions, and steps of the process serve to provide the reader with as much flexibility and power as possible in orchestrating the text.

### BRIEF DESCRIPTION OF THE SEVERAL VIEWS OF THE DRAWING

Not Applicable

### DETAILED DESCRIPTION OF THE INVENTION

Reader Interfaced Text Orchestration [RITO] is a process that uses a text in digital form, a computer, a program, a display, an interface, a reader, and the reader's input and feedback in order to manipulate the text in such a way that optimizes reading effectiveness and efficiency. Displays can be constructed in different ways, programs can be written in different ways, and readers can use different ways of engaging interface controls. The specifications of the process will be explained in terms of the details of its function.

### Identification

The process can begin with a user enabling a program to identify a text. This can be accomplished in several ways. The user can cut and paste the text from a variety of sources into a designated screen, tab, box, window, or other element within the program. The user can use a browse function in the program to select a text file containing the text. The user can use a method called Text Mapping described below. The program can be written in such a way that it is linked to the particular text. Or other methods can be employed to enable the program to identify the text.

### Text Sequence, Punctuation, Formatting, and Languages

The Text Sequence, or Sequence, is the order elements of the text appear in the text. For example, in the text [John ate Nancy's popsicle.], the Sequence consists first of [John], then [ate], then [Nancy's], then [popsicle.]. The text may have started with the capital letter [J], but RITO makes use of units of meaning, which, in English and other alphabetic languages, are individual words and not individual letters, except, of course, in the rare cases wherein individual letters, such as [a] and [I] in English, comprise whole words. RITO recognizes spaces, as well as paragraph breaks and indentations, as determining the boundaries between words in the Sequence. RITO includes punctuation marks with the words to which they are most proximate, such that, as in the example above, the apostrophe is included within [Nancy's] and the period is included within [popsicle.]. This punctuation and boundary scheme is used for other alphabetic languages as well. Thus, in this application and specification when it is said that [a word] flashes within a field, it is understood to include its proximate punctuation. In pictographic languages, RITO recognizes each graphically connected symbol as one unit of meaning. The program that serves as an element of RITO would have to be configured differently to order the Sequence of different languages, as appropriate to their horizontal and vertical, left and right progressions. For the purposes of the present application and specification, RITO will be discussed in terms of its use with the written English language.

### Text Mapping

Text Mapping constitutes one method of enabling the program to identify the text. Employing this method, the user places one or more indicators in the text to be identified. If one indicator is placed, the program identifies the text and recognizes the position of that indicator as the beginning of the Text Sequence. If a second indicator is placed, the program recognizes its position as the end of the Text Sequence. If a third indicator is placed, the program recognizes the position of second indicator as the end of one segment in the Text Sequence and the third indicator as the beginning of a succeeding segment of the Text Sequence. If a fourth indicator is placed, the program recognizes the position of the fourth indicator as the end of that segment, and, if no other indicators are placed, the end of the Sequence. If further indicators are placed, the program recognizes every odd numbered indicator, that is, the first, third, fifth, and so on, as the beginning of succeeding segments of text in the Text Sequence. It correspondingly recognizes every even numbered indicator as the end of succeeding segments of text in the Text Sequence, the last even numbered indicator marking the end of the Text Sequence. If an odd number of indicators is placed, the program will identify as much text as it can recognize following the last indicator as being part of the Text Sequence.

### Flash Rate and Flow Rate

The Flash Rate is a quantification of flashes in terms of time. It can be expressed using seconds, or minutes, or any other unit of time. A useful way to express Flash Rate is in flashes per minute, or fpm.

The Flow Rate is a quantification of words in terms of time. It can be expressed using seconds, or minutes, or any other unit of time. A useful way to express Flow Rate is in words per minute, or wpm.

If the program were configured to flash one word at a time within one field, a Flash Rate of 60 fpm would mean 60 flashes of text occur every minute, or one flash every second. This would correspond to 60 wmp as well. A Flash Rate of 240 fpm would mean 240 flashes would occur every minute, etc.

If the program were configured to use 2 fields and include 3 words in each field for each flash, this would mean every flash would consist of 6 words. A Flash Rate of 200 fpm would correspond to a Flow Rate of 1200 wpm.

### Viewer

The Viewer is the part of the program that contains the field or fields within which the text flashes. It could be a screen, tab, box, window, or other program element separate from any other, such as the element employed identify the text. The appearance of the Viewer, the number of fields it contains, the size or sizes of the field or fields, and the appearance or appearances of the field or fields, are all customizable using the settings of the program. A functional and possible default configuration of the Viewer is described herein for the purpose of explaining the process.

The Viewer should take up the majority of the display and should have a simple and uncluttered appearance in order to minimize visual distraction to the user. It can therefore be described as its own screen, though this should not be interpreted to specify a particular rendering of the program used in RITO. In RITO's most basic function, and in one possible default configuration, the Viewer would contain one field in the center of the screen. The field would be of an average size, appearing perhaps 4 inches long and 1½ inches tall on a 17 inch screen. The field might appear as a white rectangle against a soft blue background.

### Controls

The RITO process makes use of several controls, which are functions that can be engaged while the text is flowing. One way a program can make these controls operable is to assign each to a separate implement in an interface, such as a key on a keyboard, a button on a touch screen, a direction on a joystick, etc. RITO's controls are as follows:

Start/Pause—This control begins the flow of text. It can also pause the flow. Once paused, if this control is engaged again, it resumes the flow of text at the same speed the text was flowing when paused.

Stop—This control stops the flow of text.

Faster—This control speeds up the flow of text, that is, it increases the Flash Rate while the text is flowing. If engaged when the flow is Stopped or Paused, this control functions as Start.

Slower—This control slows down the flow of text, that is, it decreases the Flash Rate while the text is flowing. It has no function when the flow is Stopped or Paused.

Jump Forward—This control causes the Viewer to jump forward in the Text Sequence from the position at which the control was engaged, according to a specified interval, such as 20 words, 7 flashes, or 10 seconds. The interval is determined by a setting either customized by the user or established by the programmer as a default. A particularly useful interval to specify is about 4 seconds. Multiple Jump Forward controls can be enabled, each with its own specified interval.

Jump Back—This control causes the Viewer to jump backward in the Text Sequence from the position at which the control was engaged, according to a specified interval, such as 13 words, 9 flashes, or 30 seconds. The interval is determined by a setting either customized by the user or established by the programmer as a default. A particularly useful interval to specify is about 4 seconds. Multiple Jump Back controls can be enabled, each with its own specified interval.

Jump Forward To—This control jumps forward from the position in the Text Sequence at which it is engaged to a specified formatting element, such as the next chapter beginning in the Text Sequence, the third next sentence beginning in the Text Sequence [in other words, not the beginning of the next sentence, or the beginning of the one after that, but the beginning of the one after that], the fifth next paragraph beginning, etc. Multiple Jump Forward To controls can be enabled, each with its own specified formatting element.

Jump Back To—This control jumps backward from the position in the Text Sequence at which it is engaged to a specified formatting element, such as the previous chapter beginning in the Text Sequence, the third previous sentence beginning in the Text Sequence [in other words, not the beginning of the previous sentence, or the beginning of the one before that, but the beginning of the one before that], the fifth previous paragraph beginning, etc. Multiple Jump Back To controls can be enabled, each with its own specified formatting element.

### Settings

RITO is an elaborate and flexible process. Its various controls and the extensive dynamics of its function allow a reader to more thoroughly interface with the process and more effectively orchestrate the text. As such, many of RITO's functions can be customized by the reader. These settings are typically input using a screen, tab, box, window, or other program element separate from the one used to identify the text and the one used to facilitate the Viewer, though this is not necessary. Settings are usually input when the text in not flowing. Readers who have some experience using the RITO process might be familiar enough to customize many or all the settings before beginning a particular text. RITO's settings are as follows:

Flash Rate—This setting allows the user to present a desired Flash Rate, that is, a quantification of flashes in terms of time. A useful way Flash Rate can be set is in terms of flashes per minute, or fpm. The user can set the Flash Rate at 300 fpm, for instance, or 820 fpm. A user should set the Flash Rate at a level at which he can, with focus and sustained effort, achieve a desired threshold of comprehension. There are, of course, some practical limitations due to experience, hardware, software, cognition, and anatomy. But there is a lot of room within these limits for readers to make excellent use of RITO, and to improve with practice.

### Field Settings

Number of Fields—This setting allows the user to specify the number of fields used by the Viewer, that is, the number of fields within which text will flash. While there are practical and theoretical limits to a reader's ability, four or five fields is not impossible. The most basic setting, and the one a program would conceivably include as a default, would be one field.

Field Size—This setting allows the user to customize the size of each field. He can do so graphically, by visually adjusting the size of a model of the field, numerically, by specifying field measurements, or through some other method. If Number of Fields is set at more than one, Field Size should be customizable for each individual field. As a matter of convenience in the case of multiple fields, setting Field Size for the first field can automatically set identical sizes for the other fields, which can then be individually adjusted if desired. Typically, in the case of multiple fields, uniform Field Size is advantageous.

Field Position—This setting allows the user to specify the position at which he would like the field to appear on the screen. He can do so graphically, by visually adjusting the position of a model of the field, numerically, by specifying field coordinates, or through some other method. If Number of Fields is set at more than one, Field Position should be customizable for each individual field. As a matter of convenience in the case of multiple fields, setting Field Position for the first field can automatically set Field Position for the other fields such that the first appears directly above the next, and so on. Each field can then be individually adjusted if desired. Typically, in the case of multiple fields, it is advantageous to have one field positioned directly above another so that the group of fields is centered on the display.

Text Size—This setting allows the user to customize the size of text in each field. If Number of Fields is set at more than one, Text Size should be customizable for each individual field. As a matter of convenience in the case of multiple fields, setting Text Size for the first field can automatically set identical sizes for the text in other fields, which can then be individually adjusted if desired. Typically, in the case of multiple fields, uniform Text Size is advantageous.

Number of Words—This important setting allows the user to customize the number of words that appear within each field during each flash. He can specify 1 word, for instance, or 4 words, etc. If Number of Fields is set at more than one, Number of Words should be customizable for each individual field. As a matter of convenience in the case of multiple fields, setting Number of Words for the first field can automatically set identical numbers for the other fields, which can then be individually adjusted if desired. Typically, in the case of multiple fields, uniform Number of Words setting for each field is somewhat advantageous. This setting has a special option called Field Limit. If Field Limit is enabled, the number of words in each flash will vary and the maximum number of whole words will appear in each field, as determined by the constraints of Field Size, Text Size, and the length of the particular words in the Text Sequence.

It is worth noting that some words are longer than others. If Number of Words is set at 3, and 3 particularly long words appear in the Sequence, the program should automatically include the maximum number of words that can fit in the field up to and including 3 words, leaving any words that would not fit for the next flash. If a particular word is too large to fit in a field, even by itself, the program should break it up into parts and display the parts in separate fields and/or separate flashes while preserving the Text Sequence.

### Control Settings

Start Preference—This setting allows the reader to determine whether engaging the Start control initially or from a Stopped position begins the flow of text gradually [Gradual Start] or at the full speed indicated in the Flash Rate setting.

Gradual Start Rate—This setting determines the rate at which a Gradual Start will increase the Flash Rate until the preset Flash Rate is reached. It can be set to increase the Flash Rate at a rate of 100 fpm per second, for instance, or 50 fpmps.

Faster Rate—This setting allows the reader to customize the rate at which engaging the Faster control increases the Flash Rate. It can be set at 100 fpmps, for instance, in which case engaging the Faster control while the text is flowing would increase the Flash Rate at a rate of 100 flashes per minute per second.

Slower Rate—This setting allows the reader to customize the rate at which engaging the Slower control decreases the Flash Rate. It can be set at 40 fpmps, for instance, in which case engaging the Slower control while the text is flowing would decrease the Flash Rate at a rate of 40 flashes per minute per second.

Jump Forward Setting—This setting allows the user to create multiple Jump Forward controls as well as customize the interval for each one. Intervals can be set in terms of flashes, words, or time.

Jump Back Setting—This setting allows the user to create multiple Jump Back controls as well as customize the interval for each one. Intervals can be set in terms of flashes, words, or time.

Jump Forward To Setting—This setting allows the user to create multiple Jump Forward To controls as well as customize the formatting element each control causes the Viewer to jump forward to.

Jump Back To Setting—This setting allows the user to create multiple Jump Back To controls as well as customize the formatting element each control causes the Viewer to jump back to.

I claim:

1. A process for manipulating text in a way that facilitates reading, comprising the steps of:
(a) enabling a program to identify a text having multiple words;
(b) flashing the words of said text in sequence within a restricted field on a display.

2. The process for manipulating text of claim 1, wherein the flashing of said text in sequence is performed with one word at a time, within the restricted field.

3. The process for manipulating text of claim 1, wherein the flashing of said text in sequence is performed with more than one word at a time, within the restricted field.

4. The process for manipulating text of claim 1, wherein the flashing of said text in sequence is performed within more than one restricted field on the display, one word at a time within each field.

5. The process for manipulating text of claim 1, wherein the flashing of said text in sequence is performed within more than one restricted field on the display; more than one word at a time within each field.

6. The process for manipulating text of claim 1, further comprising the steps of:
(a) setting, increasing, or decreasing the rate at which words are flashed while the words of said text are flashing;
(b) setting, increasing, or decreasing the rate at which words are flashed before the words of said text begin flashing; and/or
(c) setting, increasing, or decreasing the rate at which words are flashed while the flashing of the words of said text is stopped.

7. The process for manipulating text of claim 1, further comprising the step of pausing or resuming the flashing of the words of said text.

8. The process for manipulating text of claim 1, further comprising the step of jumping forward or backward an interval in the sequence or to a designated position in the sequence.

9. A process for manipulating text in a way that facilitates reading, comprising the steps of:
(a) enabling a program to identify a text having multiple words;
(b) flashing the words of said text in sequence within a restricted field on a display;
(c) flashing the words of said text in sequence one word at a time, within the restricted field;
(d) flashing the words of said text in sequence more than one word at a time, within the restricted field;
(e) flashing the words of said text in sequence within more than one restricted field on the display, one word at a time within each field;
(f) flashing the words of said text in sequence within more than one restricted field on the display; more than one word at a time within each field; and/or
(g) setting, increasing, or decreasing the rate at which words are flashed either while the words of said text are flashing or while the words of said text are not flashing.

10. The process for manipulating text of claim 9, further comprising the step of adjusting the size or sizes of said field or fields.

11. The process for manipulating text of claim 9, further comprising the step of adjusting the location or locations of said field or fields.

12. The process for manipulating text of claim 9, further comprising the step of setting the number of the words to flash in said field or fields as limited by the size or sizes of said field or fields.

13. The process for manipulating text of claim 9, further comprising the step of customizing the number of the words to be flashed in said field or fields.

14. The process for manipulating text of claim 9, further comprising the step of gradually and automatically increasing the rate of flashing words to a desired limit.

15. The process for manipulating text of claim 9, further comprising the step of adjusting the rate of said increase or the rate of said decrease.

16. The process for manipulating text of claim 9, further comprising the step of adjusting the size said text appears within said field on said display.

17. The process for manipulating text of claim 9, further comprising the steps of:
(a) jumping forward or backward an interval in the sequence or to a designated position in the sequence;
(b) adjusting said interval; and/or
(c) determining said position.

18. The process for manipulating text of claim 9, further comprising the step of pausing or resuming the flashing of the words of said text.

19. A process for manipulating text in a way that facilitates reading, comprising the steps of:
(a) enabling a program to identify a text having multiple words;
(b) flashing the words of said text in sequence within a restricted field on a display; and
(c) setting, increasing, or decreasing the rate at which words are flashed either while the words of said text are flashing or while the words of said text are not flashing.
